(19) United States
(12) Patent Application Publication
(10) Pub. No.: US 2010/0080679 A1
(43) Pub. Date: Apr. 1, 2010

(54) Machine designed to move objects of transportation side to side

(76) Inventor: William Welzmiller Stebbins, JR., Sparta, TN (US)

Correspondence Address: Law Offices Eric R. Benson, Esq., 6A Hillside Lane, Westford, VT, 05494-9769, US

(21) Appl. No.: 12/586,646

(22) Filed: Sep. 25, 2009

Related U.S. Application Data
(60) Provisional application No. 61/194,498, filed on Sep. 26, 2008.

(51) Int. Cl. B66F 7/00

(52) U.S. Cl. 414/678

(57) ABSTRACT

This invention relates to a side to side article moving device that is capable of lifting an object and then moving it side to side. The device is designed to be attached under an article, such as a motor vehicle, piece of equipment, trailer or other object that ordinarily would not be capable of lateral or circular motion within confined areas. The device allows a user to remotely lift an object and move it side to side from a vantage point that is both safe and efficacious for the intended move.

### BACKGROUND ART

The use of trailers that are towed behind a motor vehicle has been known in the art for nearly two centuries. With the advent of the modern transportation system people with many differing transportation needs are now able to utilize trailers for various purposes. Tractor trailers that carry tens of thousands of kilograms of freight are in common use on highways all over the world. The general public use trailers on the highways and on private property for a wide range of purposes from hauling livestock, to equipment, to refuse, to taking the family on vacation in a camper trailer or a recreational vehicle or RV.

Similarly, the use of various vehicles of significant length has become common place in the world. These lengthy vehicles are used for similar purposes as trailers and are used in commercial and industrial applications as well as by the general public.

One of the consequences of increased transportation activity is the inevitable congestion that occurs. It is now a common experience among operators of trailers and vehicles of significant length to end up in a location where turning the trailer or long vehicle is simply not possible since the turning radius of the trailer or vehicle is inherently limited. Consequently there are occasions when such an operator of a trailer or long vehicle is stuck (e.g. boxed in) and unable to move without damaging their equipment or other object that is preventing their egress by ordinary means. At times, many hours are lost by such an operator who must wait for the congestion that got them stuck to gear. Despite this problem there has been no development of an acceptable solution in the transportation art. The current invention is a device specifically designed to elevate a trailer or vehicle that has been effectively rendered unmovable and then move it in a direction generally perpendicular to the ordinary direction of travel of the trailer or vehicle. The device is attached to the equipment in such a manner as not to interfere in its ordinary use thereby being available for use to move the equipment from side to side immediately should the need arise.

Given the geometric increase in traffic on the world's highways there is a growing need for such a novel device. In particular the recreational vehicle industry has exploded in recent decades and many members of the general public are buying and using these large trailers and vehicles. Many such individuals lack significant experience in handling these trailers and vehicles and as a result they have been more prone to get “stuck.” It is not uncommon for the operators of this large equipment to park in parking spots that appear to be unencumbered and upon their return they expect to have the ability to drive right out of the spot, however, inevitably upon their return they find themselves boxed in by an unknown driver who is somewhere in the mall and might not return for hours. In these situations having the ability to move their trailer or vehicle from side to side would solve this problem allowing the operator to easily and safely move their vehicle in a perpendicular direction and escape being trapped.

There are no acceptable prior art side to side article moving devices that would allow an operator of a trailer or lengthy vehicle to safely move their equipment from side to side when such movement is either required or desired. The current invention also utilizes a remote control device that permits an operator to closely and safely monitor the side to side movement of their equipment from a vantage point that permits optimal viewing and control of the entire movement and thereby avoiding the hitting of surrounding objects. This feature prevents injury and damage to property that is common place when such large equipment is being moved in tightly confined spaces from the cab of a vehicle, especially when such movements are being undertaken without another person directing the movement from outside the vehicle.

While prior art side to side moving devices may fulfill their respective particular objectives and requirements, and are most likely quite functional for their intended purposes, it will be noticed that none of the prior art disclose an apparatus that is attached to a user's equipment and available for immediate use and able to move the equipment from side to side in a generally perpendicular direction, or so-called zero radius. As such, there apparently still exists the need for a new and improved side to side article moving device to maximize the benefits to the user and minimize the space needed for its use. The current invention addresses all of these issues to provide a technology that provides a much more effective, efficient and user friendly device.

In this respect, the present invention disclosed herein substantially corrects these problems and fulfills the need for such a device.

### DISCLOSURE OF THE INVENTION

In view of the foregoing limitations inherent in the known types of side to side article moving devices now present in the prior art, the present invention provides an apparatus that has been designed to provide the following features for a user:
a device that is easily adaptable to any size of article for which side to side movement is desired.
a device that is able to retract when not in use into a position that prevents any interference with the use of the article when side to side movement is not desired.
a device of durable construction that is easy to install requiring no alternations to the article for which side to side movement is desired.
a device that may be operated remotely from a safe location and vantage point that permits a user to closely monitor the side to side movement of an article thereby avoiding collision with nearby objects and preventing damage either to the article or surrounding objects.
a device that is easy to use.

These features are improvements which are patently distinct over similar devices which may already be patented or commercially available. As such, the general purpose of the present invention, which will be described subsequently in greater detail, is to provide a field designed apparatus that incorporates the present invention. There are many additional novel features directed to solving problems not addressed in the prior art.

In the preferred embodiment disclosed herein and as more particularly illustrated on the attached drawings, a single cradle side to side article moving device comprised of four systems is depicted in said drawings. In the double cradle embodiment as illustrated the side to side article moving device incorporates additional wheel sets and hydraulic cylinders thereby permitting a user to lift and move from side to side very large or heavy objects.

It would be obvious to one skilled in the art to construct this device in different shapes and sizes. It would be obvious to one skilled in the art to have the control means used to operate the device be hard wired to the device as opposed to remote control as disclosed in the preferred embodiment. Similarly it would be obvious to manufacture this device out of some other materials like that of cast iron, cast aluminum or suitable composite as opposed to welded and bolted steel as depicted. Also, it would be obvious to utilize tracks or other similar locomotive means instead of wheels to provide the side to side movement. Additionally it is obvious to attach multiple wheels to the drive and support system to increase its carrying capacity. The preferred embodiment discloses the use of hydraulics as the means of lift and locomotion, however, it would be obvious to one skilled in the art to use compressed gas, such as air for pneumatic lifting and locomotion, or the use of electric motors or any combination of these power sources, including hydraulics, to accomplish the lift and locomotion. Lastly, it would be obvious to one skilled in the art to include a steering feature to the device that would permit a user to turn the wheels, thereby allowing the side to side movement to be adjusted in the event that a zero radius or strictly perpendicular movement if not desired.

To attain this, the present invention generally comprises four major components: 1) At least one power system means capable of lifting an article and then moving it; 2) At least one support and attachment frame structure comprised of an article attachment means; 3) At least one cradle system movably attached to both the power system means and the support and attachment frame structure; and 4) A control means by which a user can operate the device.

These together with other objects of the invention, along with the various features of novelty which characterize the invention, are pointed out with particularity in the claims which are annexed to and form a part of this patent application. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 is a top view of the Side to Side Article Moving Device single cradle embodiment including the electrical and hydraulic systems.

FIG. 2 is an exploded perspective view of the cradle section and hydraulic cylinders of the Side to Side Article Moving Device single cradle embodiment.

FIG. 3 is a fully exploded perspective view of the cradle section and hydraulic cylinders, with attachment hardware, of the Side to Side Article Moving Device single cradle embodiment.

FIG. 4 is a side view of the Side to Side Article Moving Device single cradle embodiment without the hydraulic system depicted showing the full range of motion of the cradle and wheel and tire assembly when fully lowered and fully retracted.

FIG. 5 is a rear view of the Side to Side Article Moving Device single cradle embodiment in the fully lowered position thereby elevating a trailer above a ground surface.

FIG. 6 is a top view of the Side to Side Article Moving Device double cradle embodiment.

FIG. 7 is a top view of the Side to Side Article Moving Device remote control unit.

### BEST MODES FOR CARRYING OUT THE INVENTION

### I. Preferred Embodiments

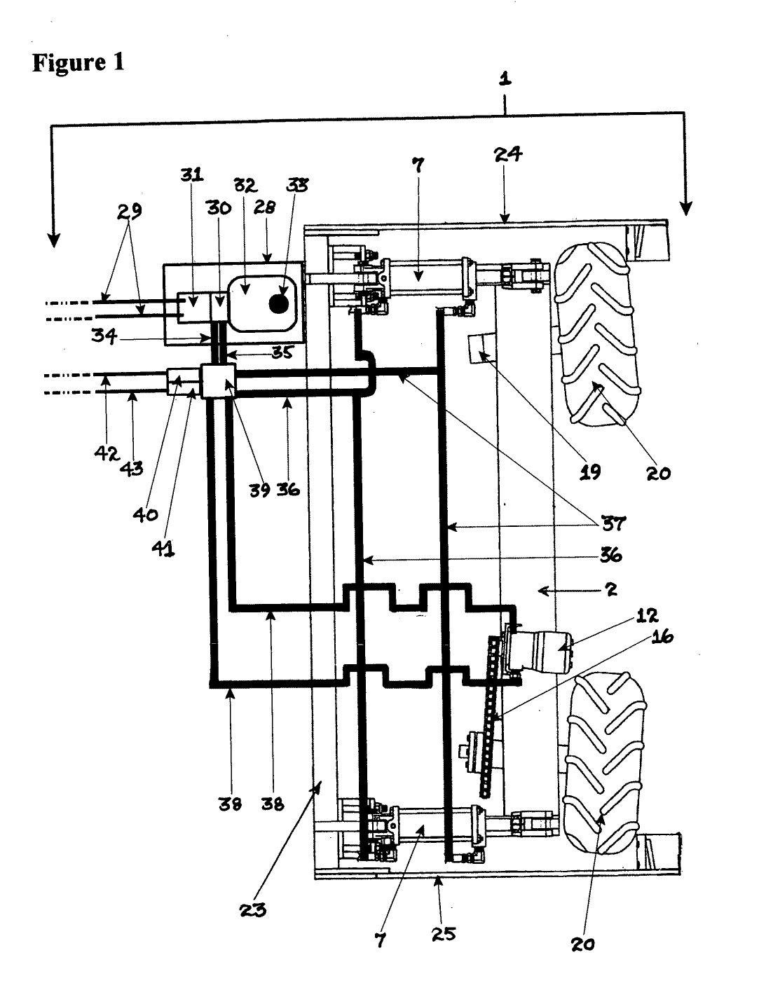

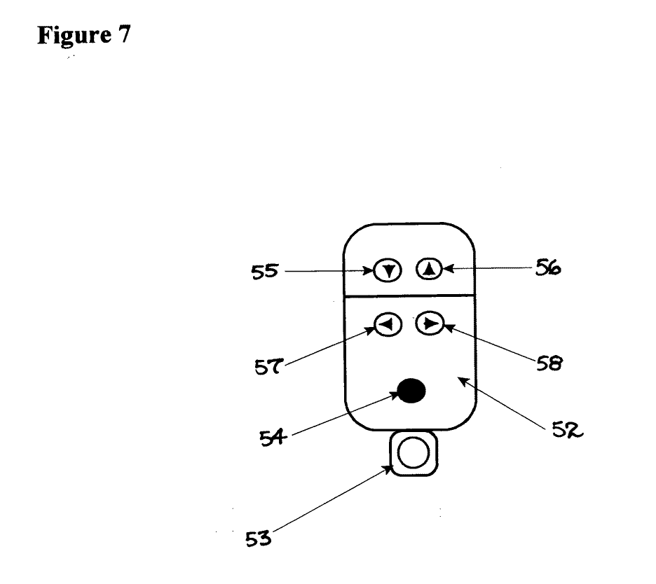

With reference now to the drawings, and in particular to FIGS. 1-7 thereof, a new and novel Side to Side Article Moving Device (1) embodying the principles and concepts of the present invention is depicted in these drawings as comprising four major components: 1) At least one power system means capable of lifting an article and then moving it; 2) At least one support and attachment frame structure comprised of an article attachment means; 3) At least one cradle system movably attached to both the power system means and the support and attachment frame structure; and 4) A control means by which a user can operate the device.

### General Description of Reference Numerals in the Description and Drawings

Any actual dimensions listed are those of the preferred embodiment Actual dimensions or exact hardware details and means may vary in a final product or most preferred embodiment and should be considered means for so as not to narrow the claims of this patent.

List and Description of component parts of the invention:
(1) Side to Side Article Moving Device
(2) Cradle Cross Member
(3) Cradle Arm
(4) Ground Surface
(5) Connector Pin
(6) Hydraulic Cylinder Cradle Mount
(7) Hydraulic Cylinder
(8) Hydraulic Cylinder S-Brace Assembly Mount
(9) Trailer
(10) Retaining Clip
(11) Hydraulic Motor Mount
(12) Hydraulic Motor
(13) Large Sprocket
(14) Sprocket Locking Ring
(15) Small Sprocket
(16) Chain
(17) Axle Shaft Bushing
(18) Axle Shaft
(19) Locking Ring
(20) Wheel and Tire
(21) Hub with Studs
(22) Lug Nuts
(23) S-Brace Assembly
(24) Right Down Brace
(25) Left Down Brace
(26) Knee Brace
(27) Cross Brace
(28) Hydraulic System Mount
(29) Hydraulic Pump Power Supply Line
(30) Hydraulic Pump
(31) Hydraulic Pump Motor
(32) Hydraulic Fluid Tank
(33) Hydraulic Fluid Tank Fill Cap
(34) Primary Stage Hydraulic Feed Line
(35) Primary Stage Hydraulic Return Line
(36) Cradle Assembly Extension Hydraulic Line
(37) Cradle Assembly Retraction Hydraulic Line
(38) Hydraulic Motor Hydraulic Line
(39) Hydraulic Directional Valve and Connection Box
(40) Cradle Assembly Hydraulic Directional Valve Receiver and Controller
(41) Hydraulic Motor Hydraulic Directional Valve Receiver and Controller
(42) Cradle Assembly Hydraulic Directional Valve Receiver and Controller Power Supply Line
(43) Hydraulic Motor Hydraulic Directional Valve Receiver and Controller Power Supply Line
(44) Hydraulic Cylinder Cradle Attachment End
(45) Hydraulic Cylinder S-Brace Assembly Attachment End
(46) S-Brace Assembly Cradle Arm Attachment Bushing Assembly
(47) Cradle Arm Hinge Bushing
(48) Hydraulic Motor Bolt
(49) Small Sprocket Bolt
(50) Sprocket Locking Ring Bolt
(51) Trailer Wheel
(52) Remote Control Unit
(53) Key Ring Attachment
(54) On-Off Switch
(55) Cradle Lowering Switch
(56) Cradle Retraction Switch
(57) Travel Left Switch
(58) Travel Right Switch
(59) Steering Mechanism

### DETAILED DESCRIPTION OF THE DRAWINGS—PREFERRED EMBODIMENT

### 1) Power System Means

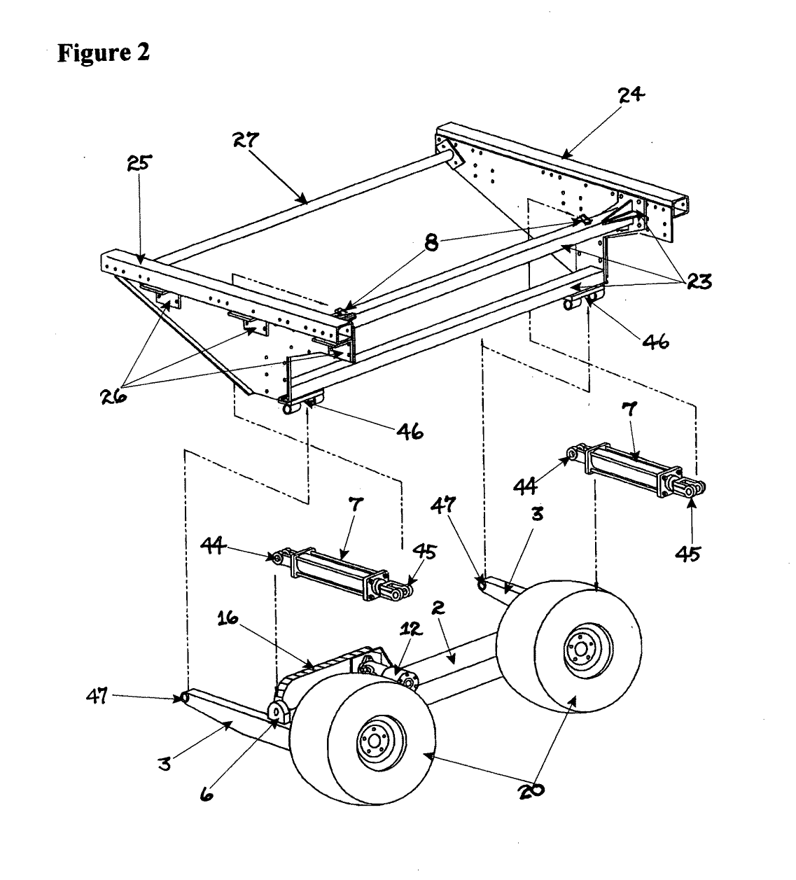

With particular reference to the preferred or single cradle embodiment of the Side to Side Article Moving Device (1) as depicted in FIGS. 1, 2 & 3 the power system means is generally comprised of the following components: two Hydraulic Cylinders (7), an Hydraulic Cylinder Cradle Attachment End (44), an

Hydraulic Cylinder S-Brace Assembly Attachment End (45), an Hydraulic Motor (12), a Small Sprocket (15), three Small Sprocket Bolts (49), an Hydraulic Pump (30), an Hydraulic Pump Motor (31), an Hydraulic Fluid Tank (32), an Hydraulic Fluid Tank Fill Cap (33), a Primary Stage Hydraulic Feed Line (34), a Primary Stage Hydraulic Return Line (35), a Cradle Assembly Extension Hydraulic Line (36), a Cradle Assembly Retraction Hydraulic Line (37), an Hydraulic Motor Hydraulic Line (38), and an Hydraulic Directional Valve and Connection Box (39).

### 2) Support and Attachment Frame Structure

With particular reference to the preferred or single cradle embodiment of the Side to Side Article Moving Device (1) as depicted in FIGS. 1, 2, 3 & 4 the support and attachment frame structure is generally comprised of the following components: two Hydraulic Cylinder S-Brace Assembly Mounts (8), an S-Brace Assembly (23), a Right Down Brace (24), a Left Down Brace (25), six Knee Braces (26), a Cross Brace (27), an Hydraulic System Mount (28), and two S-Brace Assembly Cradle Arm Attachment Bushing Assemblies (46).

### 3) Cradle System

With particular reference to the preferred or single cradle embodiment of the Side to Side Article Moving Device (1) as depicted in FIGS. 1, 2, 3, 4 & 5 the cradle system is generally comprised of the following components: a Cradle Cross Member (2), two Cradle Arms (3), two Hydraulic Cylinder Cradle Mounts (6), two Cradle Arm Hinge Bushings (47), a Hydraulic Cylinder Cradle Mount (6), an Hydraulic Motor Mount (11), A Large Sprocket (13), a Sprocket Locking Ring (14), a Small Sprocket (15), a Chain (16), two Axle Shaft Bushings (17), two Axle Shafts (18), a Locking Ring (19), two Wheels and Tires (20), two Hub with Studs (21), ten Lug Nuts (22), two Hydraulic Motor Bolts (48), three Small Sprocket Bolts (49), and three Sprocket Locking Ring Bolts (50).

### 4) Control Means

With particular reference to the preferred or single cradle embodiment of the Side to Side Article Moving Device (1) as depicted in FIGS. 1 & 7 the control is generally comprised of the following components: Hydraulic Pump Power Supply Line (29), a Cradle Assembly Hydraulic Directional Valve Receiver and Controller (40), an Hydraulic Motor Hydraulic Directional Valve Receiver and Controller (41), a Cradle Assembly Hydraulic Directional Valve Receiver and Controller Power Supply Line (42), an Hydraulic Motor Hydraulic Directional Valve Receiver and Controller Power Supply Line (43), a Remote Control Unit (52), a Key Ring Attachment (53), an On-Off Switch (54), a Cradle Lowering Switch (55), a Cradle Retraction Switch (56), a Travel Left Switch (57), and a Travel Right Switch (58).

### Preferred or Single Cradle Embodiment Major Component Interfunctionality and Use of the Device

The Side to Side Article Moving Device (1) is comprised of a Right Down Brace (24) and a Left Down Brace (25) that are rigidly attached to each other by an S-Brace Assembly (23) and a Cross Brace (27) such that the Right Down Brace (24) and the Left Down Brace (25) are generally disposed in a position parallel to each other at a distance equal to the distance between the frame members of a user selected object being lifted and moved side to side. The S-Brace Assembly (23) has rigidly attached thereto two Hydraulic Cylinder S-Brace Assembly Mounts (8) to which are pivotally attached the two Hydraulic Cylinders (7) by pivotally attaching the Hydraulic Cylinder S-Brace Assembly Attachment End (45) of each of the Hydraulic Cylinders (7) to one of two corresponding Hydraulic Cylinder S-Brace Assembly Mounts (8) that are pivotally fastened together with two Connector Pins (5) that are held in place by two Retaining Clips (10). Six Knee Braces (26), three attached to the Right Down Brace (24) and three attached Left Down Brace (25) serve to provide additional support to the frame or support structure of the user selected object being lifted and moved side to side by lying underneath the frame of the object being lifted. Once installed for use the Right Down Brace (24) and the Left Down Brace (25) are most generally bolted, but they could welded or rivotted, to the side of the frame of the user selected object being lifted and moved side to side.

The cradle system component is pivotally attached to the S-Brace Assembly (23) by pivotally attaching each of two Cradle Arm Hinge Bushings (47) of two Cradle Arms (3) to one of two corresponding S-Brace Assembly Cradle Arm Attachment Bushing Assemblies (46) that are pivotally fastened together with two Connector Pins (5) that are held in place by two Retaining Clips (10). The cradle system component is also pivotally attached to the two Hydraulic Cylinders (7) by pivotally attaching an Hydraulic Cylinder Cradle Attachment End (44) of each of the two Hydraulic Cylinder (7) to one of two corresponding Hydraulic. Cylinder Cradle Mounts (6) that are pivotally fastened together with two Connector Pins (5) that are held in place by two Retaining Clips (10).

The two Cradle Arms (3) are rigidly attached to each other by a Cradle Cross Member (2) such that the two Cradle Arms (3) are disposed to each other in a parallel position at a distance apart that allow the two Cradle Arm Hinge Bushings (47) of the two Cradle Arms (3) to align for pivotal attachment to the corresponding S-Brace Assembly Cradle Arm Attachment Bushing Assembly (46). The Cradle Cross Member (2) has two Axle Shaft Bushings (17) rigidly attached thereto generally, but not necessarily, in the same plane as the direction of the length of the two Cradle Arms (3) when said direction is taken from where the Cradle Arm (3) attaches to the Cradle Cross Member (2) to the Cradle Arm Hinge Bushing (47) of the Cradle Arm (3). The two Axle Shaft Bushings (17) are disposed at a user selected position relative to each other. In the event that the Side to Side Article Moving Device (1) is being used to lift and move an article to the side in a linear direction the two Axle Shaft Bushings (17) are disposed parallel to each other. In the event that the Side to Side Article Moving Device (1) is being used to lift and move an article to the side in a non-linear or so called radial turning direction the two Axle Shaft Bushings (17) are then disposed at an angle to each other. The mounting or attachment angle of the two Axle Shaft Bushings (17) for radial turning is dependent upon the desired distance between the two Axle Shaft Bushings (17) once attached or mounted upon the Cradle Cross Member (2). The mounting or attachment angle is calculated by drawing lines from the pivot point of the radial turn for the particular article being lifted and moved side to side (for a trailer this would be a point on the tongue of the trailer that aligns with the center point of the tow ball of a trailer hitch when being towed) to the center point of the opening at the end of each of the two Axle Shaft Bushings (17) furthest from the pivot point. The lines drawn from the pivot point will thereby establish the exact angle of attachment for the two Axle Shaft Bushings (17) thereby resulting in a “zero turning radius” movement capability when the user selected article is lifted and moved side to side by the user.

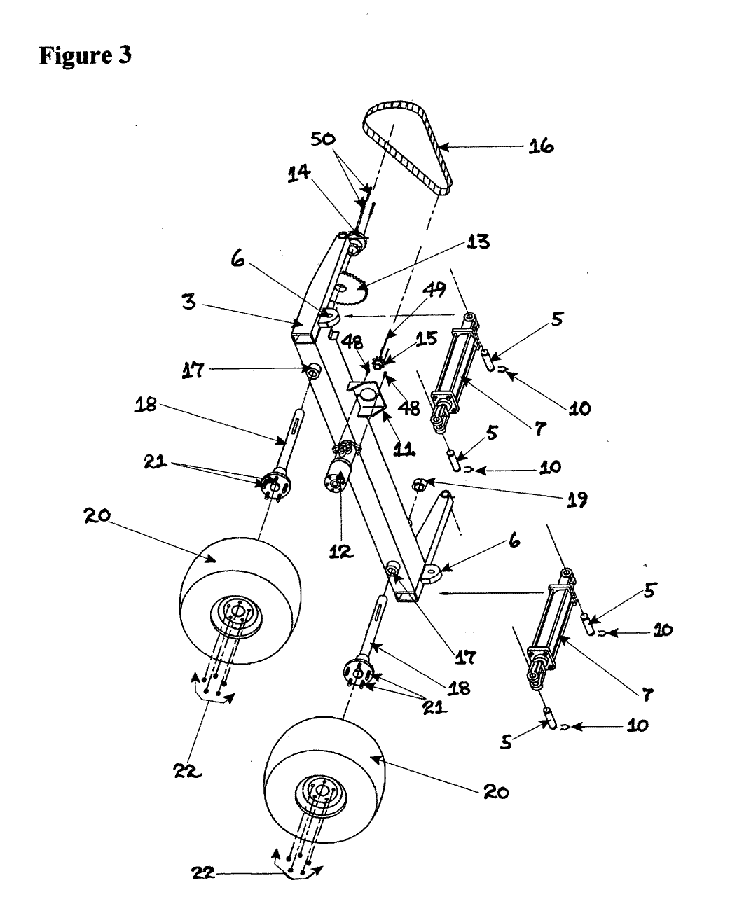

An Hydraulic Motor Mount (11) is rigidly attached to the Cradle Cross Member (2). An Hydraulic Motor (12) is then attached to the Hydraulic Motor Mount (11) by two Hydraulic Motor Bolts (48). The Hydraulic Motor (12) has attached to its drive shaft a Small Sprocket (15) by three Small Sprocket Bolts (49). Two Axle Shafts (18) each with rigidly attached Hubs with Studs (21) wherein the two Axle Shafts (18) outside diameter is roughly equal to the inside diameter of the two Axle Shaft Bushings (17). Each of the two Axle Shafts (18) are disposed inside a corresponding Axle Shaft Bushing (17) such that the Hub with Stud (21) and a Locking Ring (19) hold the Axle Shaft (18) in place permitting the Axle Shaft (18) to freely rotate therein on one such assembly and on the assembly nearest the Hydraulic Motor (12) as depicted in FIG. 3 the Axle Shaft (18) has rigidly attached thereto on the opposite end of the Hub with Studs (21) end a Large Sprocket (13) that is attached to the Axle Shaft (18) by a Sprocket Locking Ring (14) and three Sprocket Locking Ring Bolts (50) and thereby holding the Axle Shaft (18) in place permitting the Axle Shaft (18) to freely rotate within the Axle Shaft Bushing (17). A Chain (16) is removably attached to both the Small Sprocket (15) and the Large Sprocket (13) such that when a user activates the device to move an article side to side the Hydraulic Motor (12) is started and in turn rotates the Small Sprocket (15) in the user selected direction such that the Chain (16) causes the attached Large Sprocket (13) to turn which then results on the Axle Shaft (18) and attached Hub with Studs (21) to turn in the user selected direction. Two Wheels and Tires (20) are removably attached to the two Hub with Studs (21) by ten Lug Nuts (22).

An Hydraulic System Mount (28) is attached to the S-Brace Assembly (23). An Hydraulic Pump (30) is functionally attached to an Hydraulic Pump Motor (31) and an Hydraulic Fluid Tank (32) having an Hydraulic Fluid Tank Fill Cap (33) all of which together are removably attached to the Hydraulic System Mount (28). The Hydraulic Pump (30) has attached thereto a Primary Stage Hydraulic Feed Line (34) and a Primary Stage Hydraulic Return Line (35) that carry pressurized hydraulic fluid to and from the Hydraulic Pump (30) and the Hydraulic Directional Valve and Connection Box (39). A Cradle Assembly Extension Hydraulic Line (36) is attached at one end to the Hydraulic Directional Valve and Connection Box (39) and at the other end to each of the two Hydraulic Cylinders (7) at the hydraulic connection nearest the Hydraulic Cylinder S-Brace Assembly Attachment End (45) of the Hydraulic Cylinders (7). A Cradle Assembly Retraction Hydraulic Line (37) is attached at one end to the Hydraulic Directional Valve and Connection Box (39) and at the other end to each of the two Hydraulic Cylinders (7) at the hydraulic connection nearest the Hydraulic Cylinder Cradle Attachment End (44) of the Hydraulic Cylinders (7). An Hydraulic Motor Hydraulic Line (38) is attached to the Hydraulic Directional Valve and Connection Box (39) and the Hydraulic Motor (12) thereby permitting pressurized hydraulic fluid to flow in either direction through the Hydraulic Motor (12) thus permitting the wheel assembly to be driven in either rotational direction by the Chain (16) which is in turn being driven by the Small Sprocket (15) attached to the Hydraulic Motor (12).

In the preferred embodiment of the Side to Side Article Moving Device (1) as depicted in FIGS. 1,2,3,4,5 & 7 the hydraulic system as hereinabove described is powered by electricity that provides the motive power for the Hydraulic Pump Motor (31) which in turn drives the Hydraulic Pump (30). In most applications this power would be 12 volt DC current that would be transmitted to the Hydraulic Pump Motor (31) by a Hydraulic Pump Power Supply Line (29). The power source may be a power source that is part of the article being lifted and moved side to side. The power source could also be integrated into the present invention or from some external power source such as a standard AC outlet with a 12 volt transformer. The power is activated and the hydraulic system engaged by a user activating an On-Off Switch (54) on a Remote Control Unit (52). The On-Off Switch (54) also activates or turns on the 12 volt power allowing transmission of that power to a Cradle Assembly Hydraulic Directional Valve Receiver and Controller (40) and an Hydraulic Motor Hydraulic Directional Valve Receiver and Controller (41) by means of a Cradle Assembly Hydraulic Directional Valve Receiver and Controller Power Supply Line (42) and an Hydraulic Motor Hydraulic Directional Valve Receiver and Controller Power Supply Line (43).

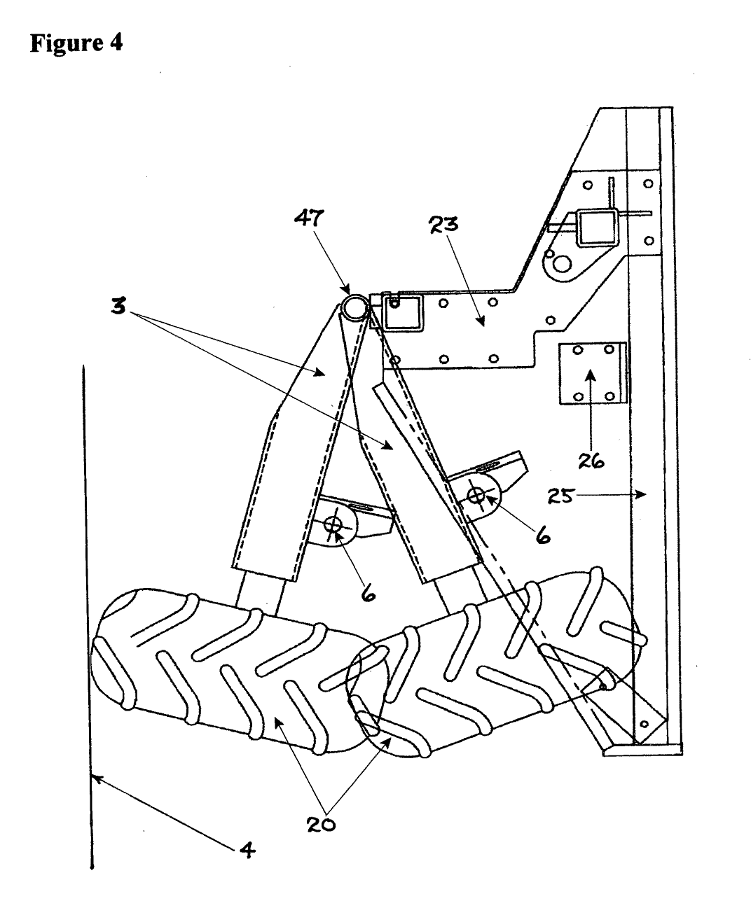

To use the Side to Side Article Moving Device (1) a user first will survey the surroundings of the article to be moved to determine the desired direction and distance of movement. The user will then place themselves in a location that is a safe distance from the object being moved well outside of its range of motion, yet close enough to be able to monitor the movement. The user then turns the device on by pressing the On-Off Switch (54) on a Remote Control Unit (52) at which point the Hydraulic Pump Motor (31) will engage and drive the Hydraulic Pump (30). With the pump running it will pressurize a volume of hydraulic fluid supplied to the Hydraulic Pump (30) from the attached Hydraulic Fluid Tank (32). The pressurized hydraulic fluid charges with hydraulic pressure the Primary Stage Hydraulic Feed Line (34) and the Primary Stage Hydraulic Return Line (35) that in turn carry pressurized hydraulic fluid to and from the Hydraulic Pump (30) and the Hydraulic Directional Valve and Connection Box (39). In order for the user to, move the article from side to side the article must first be lifted from a Ground Surface (4). This is accomplished by the user pressing the a Cradle Lowering Switch (55) on the Remote Control Unit (52) which activates the Cradle Assembly Hydraulic Directional Valve Receiver and Controller (40) thereby allowing the internal directional valve of the Hydraulic Directional Valve and Connection Box (39) to permit the flow and hydraulic pressurization of the Cradle Assembly Extension Hydraulic Line (36) which in turn extends the Hydraulic Cylinders (7) thereby lowering the cradle assembly as depicted in FIG. 4 causing the two Wheels and Tires (20) to contact the Ground Surface (4) and thereby lifting the article off the Ground Surface (4). Now that the article is elevated above the Ground Surface (4) the user presses either a Travel Left Switch (57) or a Travel Right Switch (58) on the Remote Control Unit (52) depending on the user desired movement. The Travel Left Switch (57) and the Travel Right Switch (58) on the Remote Control Unit (52) activates the Hydraulic Motor Hydraulic Directional Valve Receiver and Controller (41) thereby allowing the internal directional valve of the Hydraulic Directional Valve and Connection Box (39) to permit the flow and hydraulic pressurization of the Hydraulic Motor Hydraulic Line (38) in one or the other of the user selected directions. If the user presses the Travel Left Switch (57) the hydraulic fluid will flow in one direction in the Hydraulic Motor Hydraulic Line (38) which in turn will cause the Hydraulic Motor (12) to turn in the direction of the hydraulic fluid flow thereby causing the Wheels and Tires (20) to turn and move the article in the desired direction. In turn if the user presses the Travel Right Switch (58) the hydraulic fluid will flow in the opposite direction in the Hydraulic Motor Hydraulic Line (38) as it did when the user pressed the Travel Left Switch (57) which in turn will cause the Hydraulic Motor (12) to turn in the new or opposite direction by means of the hydraulic fluid opposite direction flow thereby causing the Wheels and Tires (20) to turn and move the article in the desired opposite direction.

Once the article is in the user desired location and the user desires to place the object back onto the Ground Surface (4) the user simply presses a Cradle Retraction Switch (56) on the Remote Control Unit (52). The Cradle Retraction Switch (56) activates the Cradle Assembly Hydraulic Directional Valve Receiver and Controller (40) thereby allowing the internal directional valve of the Hydraulic Directional Valve and Connection Box (39) to permit the flow and hydraulic pressurization of a Cradle Assembly Retraction Hydraulic Line (37) which in turn retracts the Hydraulic Cylinders (7) thereby lifting the cradle assembly as depicted in FIG. 4 causing the two Wheels and Tires (20) to lift off the Ground Surface (4) and to a retracted position depicted in FIG. 4. The Remote Control Unit (52) also has an attached Key Ring Attachment (53) for the convenience of the user to affix keys which in turn makes the Remote Control Unit (52) less likely to be lost.

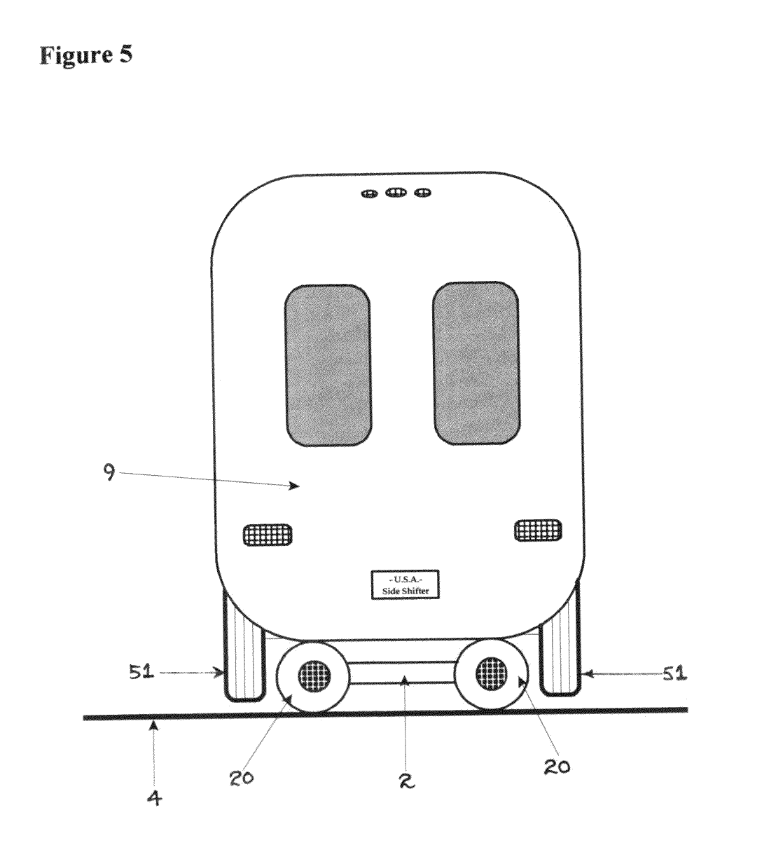

As depicted in FIG. 5, the Side to Side Article Moving Device (1) as depicted in FIG. 1, is shown attached to a Trailer (9) and the Cradle Cross Member (2) and the two attached Wheels and Tires (20) are in the lowered position by use of the power system means component thereby lifting the trailer (9) and its two Trailer Wheels (51) off the Ground Surface (4). In this position the Trailer (9) is able to be moved from sided to side.

### Double Cradle Embodiment

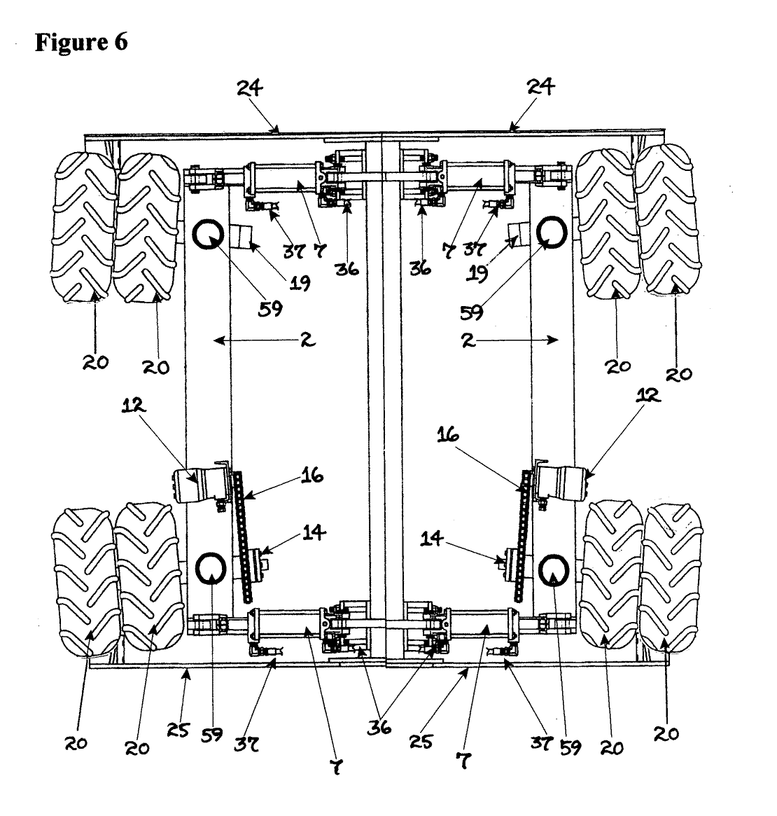

As depicted in FIG. 6, the Side to Side Article Moving Device (1) may be comprised of multiple configurations where the article is of a size and weight where multiple systems and a series of double sets of Wheels and Tires (20) may be necessary. In FIG. 6 the device depicted shows the angulation of the Wheels and Tires (20) such that the Hydraulic Motors (12) in this configuration would be driven in opposite directions causing the lifted object to turn in situ in a so called “zero radius.” The double cradle embodiment depicted in FIG. 6 also shows a steering means that could also be incorporated into the single cradle embodiment. The steering means is accomplished by a Steering Mechanism (59) that permits the Axle Shaft Bushings (17) to be rotated about a steering axis either manually or remotely by hydraulic, pneumatic, electric or other motive force means. By thus rotating the Axle Shaft Bushings (17) the wheel assembly and thus the Wheels and Tires (20) will thereby be moved or steered as well to a user desired direction.

While my above descriptions of the invention, its parts, and operations contains many specificities, these should not be construed as limitations on the scope of the invention, but rather as exemplifications of present embodiments thereof. Many other variations are possible, for example, other embodiments, shapes, and sizes of the device can be constructed and designed to work by the principles of the present invention; various materials, colors and configurations can be employed in the device's design that would provide interesting embodiment differences to users.

Accordingly, the scope of the invention should be determined not by the embodiments illustrated, but by the claims and their legal equivalents as filed herewith.

Having described my invention, I claim:

1. A side to side article moving device comprised of:
At least one frame;
the frame being further comprised of at least one article attachment means;
at least one cradle pivotally attached to the frame;
at least one cradle extension means;
at least one cradle retraction means;
at least one motive power means attached to the cradle;
at least one power source; and
at least one control means selected from the group consisting of remote control and direct control wherein the control means permits a user to control the power source and direct power from the power source means to either the cradle extension means, the cradle retraction means, or the motive power means or any combination thereof.

2. A side to side article moving device comprised of:
At least one frame;
the frame being further comprised of at least one article attachment means;
at least one cradle pivotally attached to the frame;
at least one cradle extension means;
at least one cradle retraction means;
at least one motive power means attached to the cradle;
at least one steering means attached to the cradle;
at least one power source; and
at least one control means selected from the group consisting of remote control and direct control wherein the control means permits a user to control the power source and direct power from the power source means to either the cradle extension means, the cradle retraction means, or the motive power means or any combination thereof.

3. The side to side article moving device of claim 1 wherein the cradle extension means, the cradle retractions means and the motive power means are all hydraulic and the power source is selected from the group consisting of an electrically driven hydraulic pump, an internal combustion engine driven hydraulic pump, an hydraulic pump and a pneumatically driven hydraulic pump.

4. The side to side article moving device of claim 2 wherein the cradle extension means, the cradle retractions means, the motive power means and the steering means are all hydraulic and the power source is selected from the group consisting of an electrically driven hydraulic pump, an internal combustion engine driven hydraulic pump, an hydraulic pump and a pneumatically driven hydraulic pump.

5. The side to side article moving device of claim 1 wherein the cradle extension means, the cradle retractions means and the motive power means are all pneumatic and the power source is selected from the group consisting of an electrically driven pneumatic pump, an internal combustion engine driven pneumatic pump, a pneumatic pump and an hydraulically driven pneumatic pump.

6. The side to side article moving device of claim 2 wherein the cradle extension means, the cradle retractions means, the motive power means and the steering means are all pneumatic and the power source is selected from the group consisting of an electrically driven pneumatic pump, an internal combustion engine driven pneumatic pump, a pneumatic pump and an hydraulically driven pneumatic pump.

7. The side to side article moving device of claim 1 wherein the cradle extension means, the cradle retractions means and the motive power means are all electric and the power source is selected from the group consisting of an hydraulically driven electrical generator, an internal combustion engine driven electrical generator, a battery, a solar electric generator and a pneumatically driven electrical generator.

8. The side to side article moving device of claim 2 wherein the cradle extension means, the cradle retractions means, the motive power means and the steering means are hydraulic and the power source is selected from the group consisting of an hydraulically driven electrical generator, an internal combustion engine driven electrical generator, a battery, a solar electric generator and a pneumatically driven electrical generator.

9. The side to side article moving device of claim 1 wherein the cradle extension means, the cradle retractions means and the motive power means are each individually selected from the group consisting of hydraulic, electric and pneumatic.

10. The side to side article moving device of claim 2 wherein the cradle extension means, the cradle retractions means, the motive power means and the steering means are each individually selected from the group consisting of hydraulic, electric and pneumatic.

11. The side to side article moving device of claim 1 wherein the motive power means is selected from the group that further consists of at least one wheel and at least one track.

12. The side to side article moving device of claim 2 wherein the motive power means is selected from the group that further consists of at least one wheel and at least one track.

13. The side to side article moving device of claim 2 wherein the steering means is controlled manually.
